(19) United States
(12) Patent Application Publication
(10) Pub. No.: US 2026/0245084 A1
(43) Pub. Date: Aug. 20, 2026

(54) CONTROLLING BLOCKCHAIN TRANSACTIONS BASED ON VERIFICATION PERFORMED OFFCHAIN

(71) Applicant: Unstoppable Domains, Inc., Las Vegas, NV (US)

(72) Inventors: Kiryl Berasneu, Mogilev (BY); Matthew Gould, Atlanta, GA (US); Lisa Seacat DeLuca, Bozeman, MT (US)

(21) Appl. No.: 19/058,624

(22) Filed: Feb. 20, 2025

(51) Int. Cl. G06Q 20/40; G06Q 20/36

(52) U.S. Cl. CPC G06Q 20/40; G06Q 20/367

(57) ABSTRACT

According to an embodiment of the present invention, a system for transferring assets of a computer environment comprises one or more memories and at least one processor coupled to the one or more memories. The system receives a request to transfer an onchain asset of a user to a recipient. The onchain asset resides on a blockchain and corresponds to an offchain asset of the user. A verification of one or more aspects of the offchain asset is performed offchain. The onchain asset is transferred to the recipient in response to verification of the or more aspects of the offchain asset. The offchain asset is transferred to the recipient in response to transfer of the onchain asset. Embodiments of the present invention further include a method and computer program product for transferring assets of a computer environment in substantially the same manner described above.

### TECHNICAL FIELD

Present invention embodiments relate to networking and, more specifically, to controlling blockchain transactions for transfer of domains or other assets (e.g., Web2 domains or domain names, ICANN domains or domain names, Domain Name System (DNS) domains or domain names, assets of other centralized domain systems, non-fungible tokens (NFTs), fungible tokens, Web3 or non-fungible token (NFT) domains or domain names, etc.) based on verification performed offchain.

### BACKGROUND

### Discussion of the Related Art

Web2 generally refers to a version of the web (or Internet) that utilizes a centralized Domain Name System (DNS) to translate domain names into corresponding Internet Protocol (IP) addresses in order to access a web site. In contrast, Web3 generally refers to a decentralized version of the web (or Internet) based on blockchains and peer-to-peer networks.

A decentralized marketplace enables fast transfer on a blockchain of onchain assets between individuals without an intermediary that reduces profit or otherwise impedes the experience. However, involving an intermediary may still provide some benefits, such as ensuring compliance or additional incentives. Once a blockchain transaction is executed, it is impossible to reverse (without approval from parties involved in the transaction), thereby enabling invalid transactions to stand.

### SUMMARY

According to one embodiment of the present invention, a system for transferring assets of a computer environment comprises one or more memories and at least one processor coupled to the one or more memories. The system receives a request to transfer an onchain asset of a user to a recipient. The onchain asset resides on a blockchain and corresponds to an offchain asset of the user. A verification of one or more aspects of the offchain asset is performed offchain. The onchain asset is transferred to the recipient in response to verification of the or more aspects of the offchain asset. The offchain asset is transferred to the recipient in response to transfer of the onchain asset. Embodiments of the present invention further include a method and computer program product (e.g., including one or more computer readable media with instructions executable by one or more processors) for transferring assets of a computer environment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of registering a name or other identifier for an onchain asset (e.g., Web3, blockchain, etc.) based on a name or other identifier for an offchain asset (e.g., Web2, Domain Name System (DNS), etc.) according to an embodiment of the present invention.

FIG. 4 is a procedural flowchart of a method of transferring an onchain asset between users based on verification performed offchain according to an embodiment of the present invention.

FIG. 5 is a procedural flowchart of a method of authorizing a smart contract to handle transfer of an onchain asset according to an embodiment of the present invention.

FIG. 6 is a procedural flowchart of a method of authorizing a smart contract to tender payment for transfer of an onchain asset according to an embodiment of the present invention.

FIG. 7 is a flow diagram of a method of authorizing a smart contract to tender payment for transfer of an onchain asset according to an embodiment of the present invention.

FIG. 8 is a flow diagram of a method of generating an offer to acquire an onchain asset according to an embodiment of the present invention.

FIG. 9 is a flow diagram of a method of authorizing a smart contract to transfer an onchain asset according to an embodiment of the present invention.

FIG. 10 is a flow diagram of a method of accepting an offer for an onchain asset and transferring the onchain asset according to an embodiment of the present invention.

### DETAILED DESCRIPTION

Web2 generally refers to a version of the web (or Internet) that utilizes a centralized Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

Once a transaction for a Web2 domain is conducted, a domain transfer process is initiated that transfers the Web2 domain from an owner registrar account to the registrar account of an interested user acquiring the domain. However, the transfer process is not instantaneous and can involve several operations and delays.

In order to commence the transfer, the owner ensures that the domain is unlocked at their registrar. This is typically accomplished by logging into the registrar control panel and disabling any locks that prevent unauthorized transfers. Registrar locks are in place to prevent domain theft or accidental transfers, and unlocking a domain requires action from the owner. This unlocking operation occurs before initiating the transfer to the interested user.

Once the domain is unlocked, the owner provides an authorization code (e.g. an Extensible Provisioning Protocol (EPP) code, etc.) to the interested user. This code is required by the registrar of the interested user to approve and complete the transfer. The owner can obtain this code by requesting the code from their registrar, and once the interested user has the code, the interested user can initiate the transfer process on their own registrar platform.

The domain transfer process can endure from a few hours to several days. The standard transfer period is usually between five to seven days, but in some cases, it can take up to sixty days, depending on various factors. The sixty day waiting period is particularly relevant in cases where the domain was recently registered or transferred. According to the Internet Corporation for Assigned Names and Numbers (ICANN) rules, newly registered or recently transferred domains are subject to a sixty day lock period during which they cannot be transferred to another registrar. For example, if the Web2 domain was registered or transferred to the owner within the last sixty days, the owner may not be able to transfer the domain to the interested user until this lock expires. This policy is designed to reduce domain hijacking and fraudulent transfers.

Once the transfer is initiated and all necessary confirmations are made (e.g., the authorization code, the unlock status, etc.), the interested user receives a confirmation email from their registrar, and the domain is transferred to the account of the interested user. After the transfer is complete, the interested user can renew the domain or manage the domain within their registrar control panel. Following a successful transfer, the new owner may need to update the domain WHOIS information (contact details) and may also establish domain privacy protection.

In addition, there may be transfer restrictions for Web2 domains. For example, some domain extensions may have specific rules or restrictions regarding transfers. By way of example, country-code top-level domains (ccTLDs) may have unique transfer requirements based on the country of registration.

In contrast, Web3 generally refers to a decentralized version of the web (or Internet) based on blockchains and peer-to-peer networks. A decentralized (or Web3) marketplace enables fast transfer on a blockchain of onchain assets between individuals without an intermediary that reduces profit or otherwise impedes the experience. However, involving an intermediary may still provide some benefits, such as ensuring compliance or additional incentives. Once a blockchain transaction is executed, it is impossible to reverse (without approval from parties involved in the transaction), thereby enabling invalid transactions to stand.

Accordingly, an embodiment of the present invention utilizes (or conducts) meta transactions and performs verification of data for a blockchain transaction to transfer an onchain asset prior to commencement or performance of the blockchain transaction (e.g., when the onchain asset corresponds to an offchain domain (which may be in escrow), the offchain domain can be confirmed as being properly owned and transferred before having smart contract transactions executed to transfer the onchain asset, etc.). A meta transaction is basically a transaction that enables an entity to perform a blockchain transaction on behalf of another entity. The embodiment performs the verification to enable transfer of the onchain and offchain assets (e.g., Web2, DNS, or ICANN domain names, etc.). The verification (e.g., proof of ownership and proper transfer unlocking of the offchain asset, etc.) is performed prior to proceeding with the blockchain transaction. The transfer may pertain to offchain domain names that are tokenized (or represented by an onchain asset on a blockchain). The embodiment ensures occurrence of unlocking and transfer of an offchain domain by a corresponding registrar prior to transfer of the offchain and onchain assets by a decentralized marketplace. This ensures ICANN compliance and ownership updates. In other words, the embodiment enables transfer of offchain domains with the ability to check that the offchain domain is properly owned prior to commencing a blockchain transaction to tender payment.

Onchain transactions typically incur a gas or processing fee for blockchain processing. The meta transactions may also enable gasless transactions for users and other benefits between various smart contracts. Since the meta transaction enables a blockchain transaction to be signed and sent by an entity on behalf of another entity, this enables the sending entity to handle gas (or blockchain processing) fees for the transaction. Further, the embodiment enables various verifications to be performed before any blockchain transaction is executed to reduce the chances of invalid transactions. For example, an embodiment of the present invention may perform various verifications prior to approval (e.g., verify that a person lives in a certain country before transferring a corresponding country based domain name, etc.). Moreover, an embodiment of the present invention may enable gasless transactions (e.g., denominated in a cryptocurrency backed by real world assets even when another blockchain is employed using an unbacked cryptocurrency, etc.). In addition, an embodiment of the present invention may defer the transaction for one to four weeks to wait for verifications (e.g., unlocking of offchain domains at a registrar, etc.).

An embodiment of the present invention enables data verification for blockchain transactions prior to executing the blockchain transaction to reduce invalid transactions on a blockchain. The embodiment provides offchain order creation, approval, and matching processes in an onchain marketplace or other platform.

The embodiment may further enable gasless transactions for users within a decentralized (or onchain) marketplace or other platform through utilizing (or conducting) meta transactions. The embodiment basically sends a blockchain transaction on behalf of the user and tenders payment for gas (or blockchain processing) fees. A user may sign a meta transaction in the form of a message having information for a desired blockchain transaction (e.g., asset transfer, etc.). The embodiment receives the signed meta transaction, determines the presence of sufficient funds for gas fees, and signs a blockchain transaction (corresponding to the desired blockchain transaction indicated in the meta transaction) for blockchain execution. This enables the embodiment to handle the gas fees for the user since the embodiment (and not the user) signs the actual blockchain transaction.

Transfer of an onchain or offchain asset may include any action or transaction that provides ownership, rights, registration, custody, possession, control, and/or any other interest in the onchain or offchain asset. Further, acquiring or obtaining an onchain or offchain asset may include obtaining ownership, rights, registration, custody, possession, control, and/or any other interest in the onchain or offchain asset.

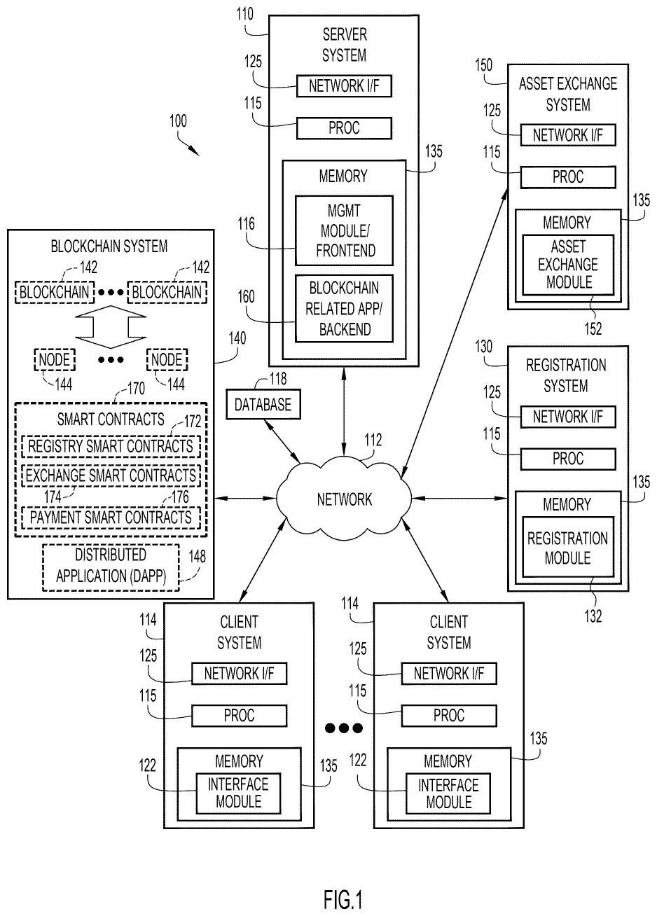

An example environment 100 for use with present invention embodiments is illustrated in FIG. 1. Specifically, environment 100 includes one or more server systems 110, one or more client or end-user systems 114, one or more registration systems 130, one or more blockchain systems 140 each implementing and maintaining at least one corresponding blockchain 142, and one or more asset exchange systems 150. Server systems 110, client systems 114, registration systems 130, blockchain systems 140, and/or asset exchange systems 150 may be remote from each other and communicate over a network 112. The network may be implemented by any number of suitable communications media (e.g., wide area network (WAN), local area network (LAN), Internet, Intranet, etc.). Alternatively, server systems 110, client systems 114, registration systems 130, blockchain systems 140, and/or asset exchange systems 150 may be local to each other, and communicate via any appropriate local communication medium (e.g., local area network (LAN), hardwire, wireless link, Intranet, etc.).

Server systems 110 include a management module or frontend 116 and one or more blockchain related applications or backend 160. Frontend 116 may interface with a user via client system 114, and/or may be of the form of an Application Programming Interface (API), to perform onchain and/or offchain asset management (e.g., for domains or other objects, marketplace or other platforms, etc.). The frontend provides a platform or marketplace that piggybacks off of (or is supported by) a smart contract for asset exchange system 150. The frontend is basically client-facing, and may process requests from any entities (e.g., user, application, service, computing or other device, backend 160, etc.).

Client systems 114 may include an interface module 122 to provide a graphical user (e.g., GUI, etc.) or other interface (e.g., command line prompts, menu screens, etc.) that enables users to access server systems 110 and blockchain systems 140 for managing onchain and/or offchain assets (e.g., domains or other objects, etc.). The interface module may include any conventional or other browser to access server systems 110 and blockchain systems 140.

Registration systems 130 include a registration module 132 that registers and manages names or other identifiers for offchain assets (e.g., Web2 domains or domain names, ICANN domains or domain names, Domain Name System (DNS) domains or domain names, etc.). By way of example, the registration system may include a conventional or other DNS server and be associated with one or more registrars.

Asset exchange systems 150 include an asset exchange module 152 that provides management and transfer of onchain assets. For example, exchange module 152 provides an onchain marketplace or other platform for management and transfer of onchain assets. An exchange smart contract 174 supports and performs blockchain transactions for the onchain platform and the frontend platform as described below. In other words, the frontend platform leverages (or is supported by) exchange smart contract 174 to perform blockchain transactions for the frontend platform. Since smart contract 174 supports the onchain and frontend platforms, blockchain and/or other transactions performed by the exchange smart contract are reflected on each of these platforms. Frontend 116 and backend 160 reside between the user (or client system 114) and exchange smart contract 174 to verify aspects of a blockchain transaction (e.g., requested by the user on the frontend platform) prior to submitting the blockchain transaction to a blockchain (e.g., and prior to the blockchain (e.g., mining or other nodes) validating the blockchain transaction). The aspects to be verified may pertain to various attributes or conditions of an onchain asset and/or corresponding offchain asset as described below.

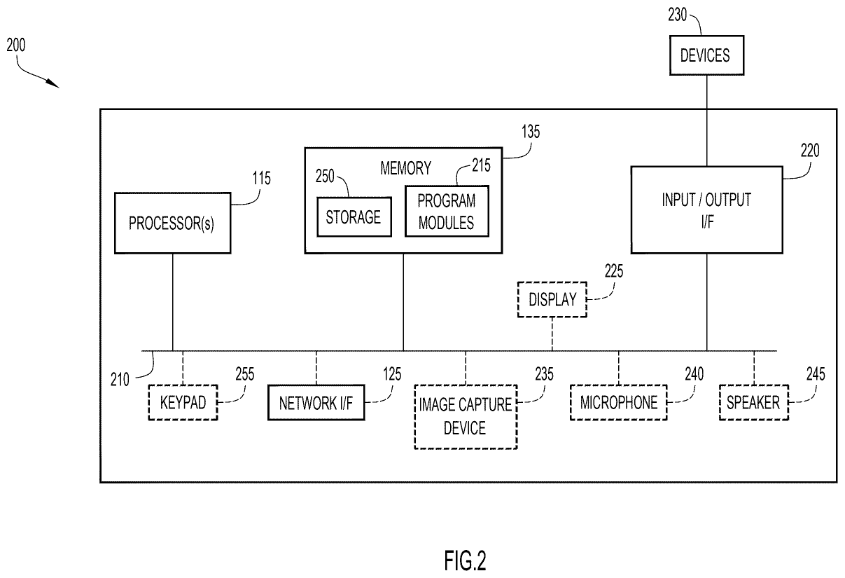

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 170) that executes on the blockchain in response to occurrence of pre-defined conditions. The smart contracts include registry smart contract 172, exchange smart contract 174, and payment smart contract 176. Exchange smart contract 174 performs blockchain transactions that support management and transfer of onchain assets for the onchain platform of asset exchange system 150 and the frontend platform of frontend 116 as described below. Registry smart contract 172 supports the frontend platform and enables performance of blockchain transactions (e.g., via exchange smart contract 174) for management and transfer of onchain assets of the frontend platform as described below. Payment smart contract 176 enables payment for blockchain transactions (e.g., via exchange smart contract 174) for transfer of onchain assets of the frontend platform as described below. The onchain assets may be associated with the same and/or various different blockchains.

Interface module 122 of client systems 114 may further provide a graphical user (e.g., GUI, etc.) or other interface (e.g., command line prompts, menu screens, etc.) that enables users to access distributed applications (dApps) 148 and/or smart contracts 170 on blockchain systems 140 for performing various operations (e.g., financial or other transactions or operations related to a blockchain, etc.). The interface module may include any conventional or other browser to access the decentralized applications (dApps) of blockchain systems 140. The interface module may natively, or include extensions to, access the decentralized applications (dApps) and/or other components of blockchain system 140. The interface module may provide a user interface to serve as a front end for a decentralized application (dApp) 148, where back end processing for the decentralized application (dApp) is performed on a blockchain system 140. Client systems 114 may further provide reports or notifications pertaining to requests from users (e.g., results of a transaction, transfers of onchain and/or offchain assets, etc.).

Backend 160 of server systems 110 performs various blockchain related operations for the frontend platform (e.g., transactions or operations related to a blockchain, etc.). Frontend 116 and backend 160 may be on the same or different server systems 110. The backend is basically blockchain-facing, and interacts with frontend 116 to enable blockchain transactions for the frontend platform. The backend processes requests from any entities (e.g., user, application, service, computing or other device, frontend 116, etc.).

A database or offchain storage system 118 may store various information for a blockchain asset (e.g., blockchain asset information, mappings of blockchain assets to blockchains, blockchain domain content, etc.). The database system may be implemented by any conventional or other database or offchain storage unit (e.g., Interplanetary File System (IPFS), etc.), may be local to or remote from server systems 110, client systems 114, registration systems 130, blockchain systems 140, and/or asset exchange systems 150 and may communicate via any appropriate communication medium (e.g., local area network (LAN), wide area network (WAN), Internet, hardwire, wireless link, Intranet, etc.).

Server systems 110, client systems 114, registration systems 130, and asset exchange systems 150 may be implemented by any conventional or other computer systems preferably equipped with a display or monitor, a base, optional input devices (e.g., a keyboard, mouse or other input device), and any software for use by present invention embodiments (e.g., server/communications software, blockchain software, frontend 116, interface module 122, registration module 132, asset exchange module 152, backend 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Frontend 116, interface module 122, registration module 132, decentralized applications (dApps) 148, asset exchange module 152, backend 160, and smart contracts 170 may include one or more modules or units to perform the various functions of present invention embodiments described below. The various modules (e.g., frontend 116, interface module 122, registration module 132, asset exchange module 152, backend 160, etc.) may be implemented by any combination of any quantity of software and/or hardware modules or units, and may reside within memory 135 of the server, client, and/or registration systems for execution by a corresponding processor 115. The various modules of the blockchain (e.g., smart contracts 170, registry smart contract 172, exchange smart contract 174, payment smart contract 176, decentralized applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, asset exchange systems 150, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing non-removable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to frontend 116, interface module 122, registration module 132, blockchain software (e.g., decentralized applications (dApp) 148, smart contracts 170, registry smart contract 172, exchange smart contract 174, payment smart contract 176, blockchain management software, etc.), backend 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user wallet typically stores the private key.

For example, in order for the user to send cryptocurrency, a message for a transaction is encrypted (or signed) using the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user account based on the transaction.

In addition, a blockchain may store software (e.g., smart contracts 170) that executes in response to occurrence of pre-defined conditions. A smart contract is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. A blockchain domain name may be a non-fungible token (NFT) domain name that is associated with a non-fungible token (NFT) stored in a user wallet account. The blockchain domain name may be associated with various information (e.g., wallet addresses or accounts, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain (e.g., authenticating operations or transactions for the blockchain domain name similar to the cryptocurrency example described above, etc.). For example, the user may have sole control to perform operations that alter content and/or functionality for the blockchain domain.

An embodiment of the present invention enables verification of data for a blockchain transaction offchain prior to commencement or performance of the blockchain transaction (e.g., when an onchain asset corresponds to an offchain domain (which may be in escrow), the offchain domain can be confirmed as being properly owned and transferred before having smart contract transactions executed to transfer the onchain asset, etc.). In other words, the embodiment performs the verification to enable transfer of the corresponding offchain assets (e.g., Web2, DNS, or ICANN domain names, etc.).

Transfer of an onchain or offchain asset may include any action or transaction that provides ownership, rights, registration, custody, possession, control, and/or any other interest in the onchain or offchain asset. Further, acquiring or obtaining an onchain or offchain asset may include obtaining ownership, rights, registration, custody, possession, control, and/or any other interest in the onchain or offchain asset.

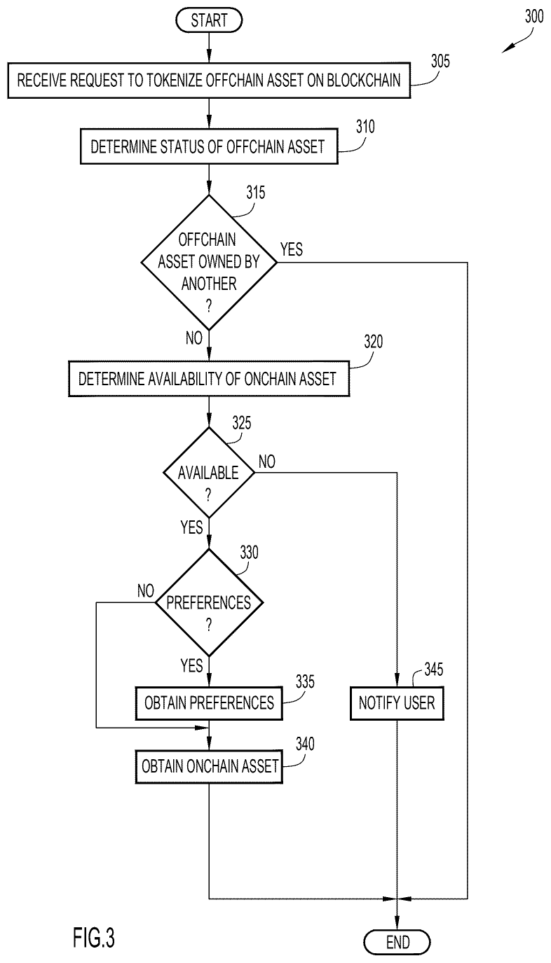

A method 300 of registering a name or other identifier for an onchain asset (e.g., Web3, blockchain, etc.) based on a name or other identifier for an offchain asset (e.g., Web2, Domain Name System (DNS), etc.) (e.g., via frontend 116, registration module 132, smart contract 146, distributed application (dApp) 148, backend 160, server system 110, client system 114, registration system 130, and/or blockchain system 140) according to an embodiment of the present invention is illustrated in FIG. 3. Initially, a user may register, or desire to register, a name or other identifier of an offchain asset (e.g., Web2, ICANN, Domain Name System (DNS), etc.) for an onchain asset (e.g., Web3, blockchain, non-fungible token (NFT), etc.) via frontend 116. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), system other than a decentralized system described above, etc.). The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.). A user may include, or be associated with, any type of entity (e.g., individual, company, organization, decentralized autonomous organization (DAO), etc.).

Frontend 116 receives a request (e.g., on the frontend platform, etc.) for the name or other identifier of the offchain asset to tokenize (or create a corresponding non-fungible token (NFT) for) the offchain asset on a blockchain at operation 305. The frontend may receive and process requests from any entities (e.g., user, application, service, computing or other device, client system 114, etc.). The frontend performs a look-up of the name of the offchain asset at operation 310 to determine registration/ownership of the offchain asset by another user (e.g., indicating unavailability of the offchain asset). By way of example, the offchain asset may include an offchain domain name (e.g., Web2, Domain Name System (DNS), etc.), and frontend 116 requests information (e.g., DNS records, etc.) for the offchain domain name from registration system 130. The information from the registration system indicates registration/ownership or availability of the offchain asset.

When the offchain asset is not registered/owned by another user as determined at operation 315, frontend 116 determines availability of the name of the offchain asset for an onchain asset at operation 320. In other words, the frontend determines availability of an onchain representation of the offchain asset. For example, the frontend (e.g., via backend 160) accesses an intended blockchain 142 for the onchain version (e.g., via a blockchain system 140), and performs a look-up for the name of the offchain asset on the blockchain. Absence of a record on the blockchain for the name indicates the name for the offchain asset (or onchain version) is available on the blockchain. Further, frontend 116 may perform a look-up for the name (e.g., on a blockchain, marketplace or other platform, etc.) to determine availability of the onchain asset for transfer from another user. The intended blockchain may be selected by a user, and the name for the look-up may include the name portion of the name of the offchain asset (e.g., with the same extension, a corresponding extension for the intended blockchain, etc.).

When an onchain representation of the offchain asset is available as determined at operation 325, payment and other preferences may be provided or selected for acquiring the onchain version (e.g., tokenizing the offchain asset on the blockchain). The options or preferences may include payment to acquire the onchain representation, an intended blockchain or other system to publish or mint the onchain version, a smart contract for the transaction, etc. When preferences are required as determined at operation 330, frontend 116 obtains the preferences at operation 335. The preferences may be stored offchain in database system 118, or received from an administrator.

The name for the onchain version is acquired at operation 340. For example, frontend 116 (e.g., via backend 160, corresponding registry smart contract 172, and/or distributed application (dApp) 148) publishes or mints the name for the onchain version (e.g., represented by a non-fungible token (NFT)) on a corresponding blockchain, and/or transfers the onchain asset from a current owner to the user (e.g., places the onchain asset in a user wallet account). The acquisition of the onchain version may be performed based on any required preferences. This may be accomplished by frontend 116 (e.g., via backend 160, corresponding registry smart contract 172, and/or distributed application (dApp) 148) providing a transaction to the blockchain indicating acquisition of the onchain version (or NFT) by the user. In addition, various information for the onchain version (e.g., user information, asset information, wallet information, etc.) may be stored onchain and/or in offchain storage (e.g., database system 118, etc.).

The offchain and onchain versions may be linked based on the name or other identifier. For example, frontend 116 (e.g., via registration module 132 of registration system 130) may set a record associated with the offchain asset to indicate the onchain representation. By way of example, a Domain Name System (DNS) canonical name or other record may be created or modified to include an identifier for the onchain asset (e.g., onchain domain name, wallet address, etc.).

Further, frontend 116 (e.g., via decentralized application (dApp) 148 and/or backend 160) may set or update records associated with the onchain asset to indicate information for the offchain asset. For example, an onchain or offchain record may be created or modified to include an identifier for the offchain asset (e.g., an offchain domain name to be linked, IP address, registry, etc.).

Once the onchain and offchain representations are acquired, transactions may be conducted (e.g., via frontend 116 and/or backend 160) using the names for the onchain or offchain assets. For example, the information in the records for the offchain domain may be used to resolve data for the onchain representation (e.g., a user may send cryptocurrency to an offchain domain (based on an associated record indicating the onchain domain), etc.). The transaction may be analyzed to determine the actions, underlying system, and the corresponding representation needed for that system. By way of example, when the transaction is for an onchain representation (or domain) for an onchain system using an offchain representation (or domain), a lookup of the Domain Name System (DNS) canonical name or other record associated with the offchain representation (e.g., Web2/offchain/DNS version of the onchain domain) is performed to obtain the onchain representation for conducting the transaction. A similar approach may be used for offchain transactions using onchain representations.

Further, transactions conducted for an onchain or offchain representation may automatically be applied to the linked (offchain or onchain) representation. By way of example, selling an offchain representation also sells the linked onchain representation (and vice versa), transferring the onchain representation also transfers the linked offchain representation (and vice versa), making available for auction the onchain representation also makes the linked offchain representation available (and vice versa), purchasing an offchain representation brand new also purchases the linked onchain representation (and vice versa), taking out a loan may apply to the linked representations or be conducted using one of the linked representations, extending expiration of (or renewing) an offchain representation extends (or renews) the registration for a linked onchain representation (and vice versa), and/or transferring an offchain domain to a new registrar (in the case of domains) transfers the onchain domain to the new registrar (or vice versa) or the transfer may be conducted using one of the linked representations.

When the onchain asset is not available based on the look-up (e.g., an onchain representation of the offchain asset is already owned by the user or by another user that is not making the onchain asset available for transfer) as determined at operation 325, frontend 116 alerts or notifies the user at operation 345. The notification may indicate ownership information for the onchain version of the offchain asset (e.g., the user or other user owning the onchain asset, etc.), and may be presented on a client system 114 (e.g., via interface module 122, etc.).

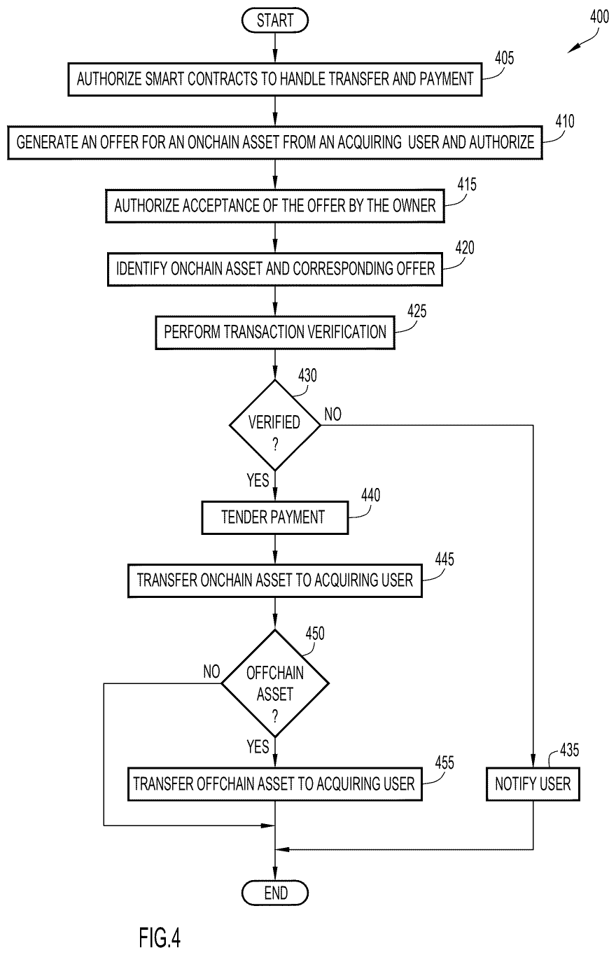

A method 400 of transferring an onchain asset between users based on verification performed offchain (e.g., via frontend 116, registration module 132, decentralized application (dApp) 148, backend 160, registry smart contract 172, exchange smart contract 174, payment smart contract 176, server system 110, client system 114, registration system 130, blockchain system 140, and/or asset exchange system 150) according to an embodiment of the present invention is illustrated in FIG. 4. By way of example, method 400 is described with respect to an offchain asset including a Web2, ICANN, or Domain Name System (DNS) domain or domain name and an onchain asset representing the offchain asset by a non-fungible token (NFT). However, any onchain and offchain assets may be used in substantially the same manner described below.

Initially, an offchain asset (e.g., Web2 domain or domain name, ICANN domain or domain name, Domain Name System (DNS) domain or domain name, etc.) may be tokenized on a blockchain (e.g., via frontend 116, decentralized application (dApp) 148, backend 160, registry smart contract 172, etc.). For example, a request to tokenize the offchain asset is issued from an initial user via a client system 114 to registry smart contract 172 (e.g., via frontend 116, decentralized application (dApp) 148, backend 160, etc.). The initial user may be any entity owning or otherwise having rights to the offchain asset. The tokenization may be requested by any entity, such as an owner of the offchain asset, a registrar, a domain broker, a domain marketplace, etc.

A tokenized (or onchain) version of the offchain asset is created (e.g., via frontend 116, decentralized application (dApp) 148, backend 160, registry smart contract 172, etc.). Once the tokenized version is created, a domain owner may be changed to a registrar (as opposed to an individual). For example, frontend 116 may tokenize the offchain asset for the initial user on a blockchain in substantially the same manner described above (FIG. 3). The tokenization may include minting or publishing a non-fungible token (NFT) representing the offchain asset on the blockchain, and/or transferring the NFT from a previous owner to the initial user (e.g., places the onchain asset corresponding to the offchain asset in a user wallet account) via the registry smart contract. A user may include, or be associated with, any type of entity (e.g., individual, company, organization, etc.). Transfer of an onchain or offchain asset may include any action or transaction that provides ownership, rights, registration, custody, possession, control, and/or any other interest in the onchain or offchain asset. Further, acquiring or obtaining an onchain or offchain asset may include obtaining ownership, rights, registration, custody, possession, control, and/or any other interest in the onchain or offchain asset.

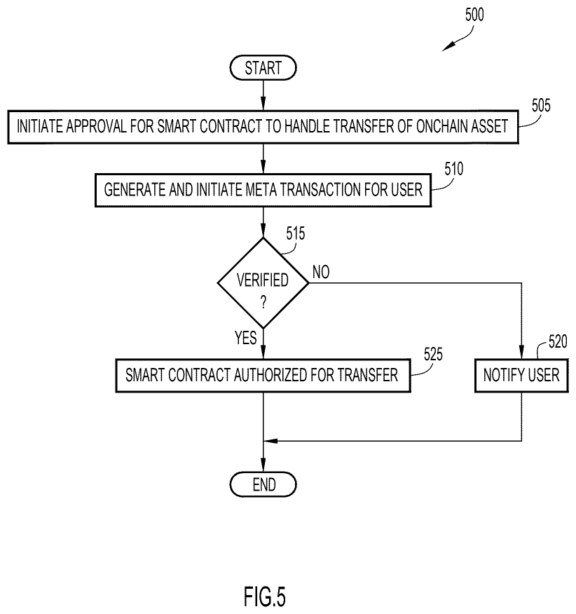

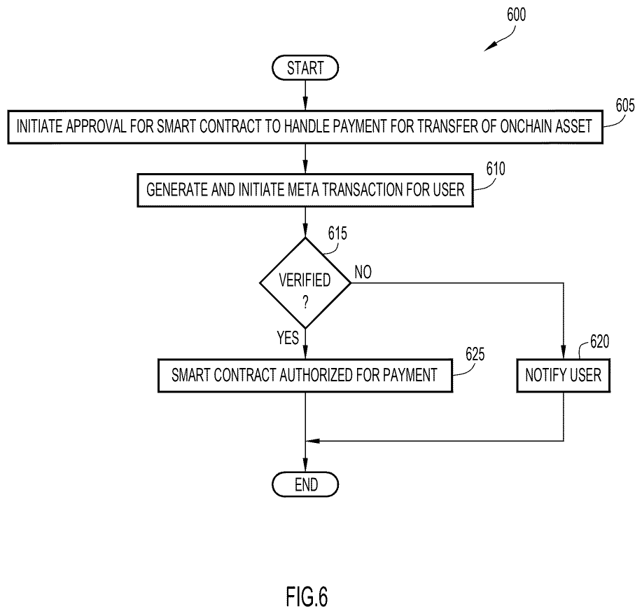

The onchain asset may be listed on the frontend platform (e.g., via frontend 116, backend 160, and/or exchange smart contract 174). The initial user and another user interested in acquiring the onchain asset each provide approval to allow exchange smart contract 174 to handle onchain asset transfers and payments at operation 405. For example, the acquiring user approves payment of cryptocurrency (e.g., US Dollar Coin (USDC), etc.) by payment smart contract 176 via exchange smart contract 174 (e.g., as described below for FIG. 5), while the initial user approves onchain asset transfers by exchange smart contract 174 (e.g., as described below for FIG. 6). Meta transactions are used (or conducted) for the approvals. A meta transaction is basically a transaction sent by an entity on behalf of another entity that enables the entity to tender payment for gas (or blockchain processing) fees. By way of example, a user may sign a meta transaction in the form of a message having information for a desired blockchain transaction (e.g., asset transfer, etc.). Since the meta transaction is in the form of a message (as opposed to an actual blockchain transaction), the meta transaction does not incur gas (or blockchain processing) fees. The entity receives the signed meta transaction, determines the presence of sufficient funds for gas (or blockchain processing) fees, and signs a blockchain transaction (corresponding to the desired blockchain transaction of the user indicated in the signed meta transaction) for blockchain execution. Since the entity signs the blockchain transaction, the entity is responsible for the gas (or blockchain processing) fees (as opposed to the user).

Backend 160 of server system 110 generates and relays these meta transactions to client systems 114 of the initial user and acquiring user for signing to provide the approvals. The meta transaction includes information for a desired blockchain transaction (e.g., approval, etc.). Backend 160 determines presence of sufficient funds for the gas (or blockchain processing) fees and signs a blockchain transaction (corresponding to the desired blockchain transaction indicated in the signed meta transaction) for blockchain execution to provide the approvals. This enables backend 160 to handle payments for gas (or blockchain processing) fees on behalf of the initial and acquiring users.

An offer from the acquiring user (e.g., for the onchain asset which may be listed on the frontend platform) is generated and authorized at operation 410. Frontend 116 of server system 110 generates an offer requested by the acquiring user (e.g., via client system 114). Backend 160 of server system 110 generates and relays a meta transaction (including information for a blockchain transaction to generate and approve the offer) to client system 114 of the acquiring user (via frontend 116) for signing to approve the offer. The signing of the meta transaction may be performed offchain (e.g., via a digital signature, etc.), or in a user wallet account as described below.

Once the meta transaction is signed and validated, backend 160 generates and signs a blockchain transaction (corresponding to the blockchain transaction indicated in the signed meta transaction) for blockchain execution to provide the offer. Since backend 160 signs the blockchain transaction, the backend is responsible for payments for gas (or blockchain processing) fees on behalf of the acquiring user. The executed blockchain transaction lists the offer (e.g., on the frontend platform via exchange smart contract 174), and the offer is provided to the initial user for acceptance (e.g., via backend 160 and frontend 116). The occurrence of the listing of the offer may be obtained from exchange smart contract 174 (e.g., notification from exchange smart contract 174, periodically query exchange smart contract 174, etc.).

The initial user authorizes acceptance of the offer at operation 415. Frontend 116 of server system 110 relays the acceptance to backend 160 of server system 110, while backend 160 generates and relays a meta transaction (including information for a blockchain transaction to accept the offer) to client system 114 of the initial user (via frontend 116) for signing to approve the acceptance. The signing may be performed offchain (e.g., via a digital signature, etc.), or in a user wallet account as described below.

Once the meta transaction is signed and validated, backend 160 generates and signs a blockchain transaction (corresponding to the blockchain transaction indicated in the signed meta transaction) for blockchain execution to provide the acceptance. Since backend 160 signs the blockchain transaction, the backend is responsible for payments for gas (or blockchain processing) fees on behalf of the initial user.

Once the approvals for the smart contracts, offer, and acceptance are established, backend 160 of server system 110 matches the offer from the acquiring user with the offer acceptance by the initial user at operation 420. The matching of the offer with the acceptance indicates the onchain asset for transfer. A blockchain transaction for transferring the onchain asset is generated and verified by backend 160 at operation 425 (e.g., via registration module 132, smart contracts 170, registry smart contract 172, exchange smart contract 174, payment smart contract 176, etc.). The verification may include verifying any quantity of aspects of the onchain and/or offchain asset. For example, when an offchain domain corresponds to the onchain asset (e.g., and may be in escrow), the offchain domain can be confirmed as being properly owned and transferred before having the blockchain transaction executed. This may be accomplished by verifying information retrieved from registration system 130 for the offchain domain. Further, gas (or blockchain processing) fees may be checked to ensure sufficient funds are available for conducting the blockchain transaction.

Moreover, the transfer of the onchain asset may be associated with various conditions (e.g., the initial and/or acquiring user owning a quantity of non-fungible tokens (NFTs) of a certain community, the initial and/or acquiring user owning specific NFTs, the initial and/or acquiring user owning related NFTs of a group, etc.). For example, the transfer of the onchain asset may be performed based on the initial and/or acquiring user having a specific type of non-fungible token (NFT) (e.g., digital art, etc.), and/or having a crypto account with a certain balance or value (e.g., above, at, or below a threshold value, such as a balance or value greater than $1000, etc.). The transfer of the onchain asset may be performed based on the initial and/or acquiring user having a quantity and type of non-fungible tokens (NFTs) (e.g., above, at, or below a threshold quantity, such as greater than 100 total domains, etc.). These conditions may be verified based on accessing and evaluating contents of the wallet account of the acquiring user before executing the blockchain transaction to transfer the onchain asset.

When the blockchain transaction is invalid as determined at operation 430 (e.g., improper ownership, incorrect data, non-compliance with conditions, etc.), backend 160 alerts or notifies the user (via frontend 116) at operation 435. The notification may indicate the reason for the invalid transaction (e.g., improper ownership, incorrect data, non-compliance with conditions, etc.), and may be presented on a client system 114 (e.g., via interface module 122, etc.).

When the blockchain transaction is valid as determined at operation 430, the blockchain transaction is executed to transfer the onchain asset from the initial user to the acquiring user. For example, payment is tendered for the onchain asset at operation 440. In this case, backend 160 of server system 110 provides information for the transfer to exchange smart contract 174. The exchange smart contract directs payment smart contract 176 to tender payment from the acquiring user to the initial user (based on the prior approval from the acquiring user). Further, the onchain asset is transferred from the initial user to the acquiring user (e.g., via exchange smart contract 174 based on the prior approval from the initial user) at operation 445.

When the onchain asset represents a corresponding offchain asset (e.g., Web2, DNS, or ICANN domain, etc.) as determined at operation 450, the corresponding offchain asset is transferred from the initial user to the acquiring user offchain at operation 455. For example, backend 160 directs registration module 132 of registration system 130 to transfer the offchain domain from the initial user to the acquiring user at operation 455. For example, DNS or other records may be edited at the current registrar to transfer the offchain asset to the acquiring user (using the same registrar). Alternatively, a request for the offchain asset to be transferred (to a new registrar) may be sent from registration system 130 to client system 114 of the initial user. The initial user performs the transfer process (e.g., with respect to unlocking and authorization codes) for management of the offchain asset in a new registrar. The offchain asset may be transferred to a registrar of choice of the acquiring user.

An embodiment ensures that the acquiring user and initial user grant permissions for exchange smart contract 174 to execute asset transfers securely. This provides smooth operation of transactions in the marketplace. An onchain and/or offchain asset may be listed on a computerized platform (or marketplace) as available for transfer prior or subsequent to the meta transactions for the permissions and/or offer generation.

A method 500 of authorizing a smart contract to handle transfer of an onchain asset (e.g., via frontend 116, backend 160, registry smart contract 172, server system 110, client system 114, and/or blockchain system 140) according to an embodiment of the present invention is illustrated in FIG. 5. The initial user approves exchange smart contract 174 to transfer the onchain asset on their behalf. This may be accomplished by granting permission through registry smart contract 172 as described below.

Initially, the initial user interacts (e.g., via client system 114) with frontend 116 of server system 110 to initiate the approval process at operation 505. A meta transaction (including information for a blockchain transaction to initiate approval) is generated by backend 160 of server system 110 and sent (via frontend 116) to the initial user for signing (via client system 114) at operation 510.

Once signed, the meta transaction is sent to backend 160 (via frontend 116) for verification (e.g., the signature is verified, etc.). The signing of the meta transaction may be performed offchain (e.g., via an offchain digital or encrypted signature, etc.), or in a crypto wallet account of the initial user. By way of example, signing of a meta transaction in the form of a message in a crypto wallet account (e.g., custodied, self-custody, etc.) generates a digital signature of the message based on the private key of the wallet account. The signed message or digital signature is decrypted for verification based on a public key (e.g., blockchain address, etc.) corresponding to the wallet account (e.g., provided by the user or user wallet account, etc.). Since the private key is unique to the wallet account, successful decryption of the message with the corresponding public key verifies the message was sent by the initial user. Further, an offchain signature may similarly be decrypted (with appropriate keys) to verify the signed meta transaction.

When the signed meta transaction is invalid (e.g., improper signature, etc.) as determined at operation 515, backend 160 (via frontend 116) alerts or notifies the initial user at operation 520. The notification may indicate the reason for the invalid signature (e.g., improper signature for transaction, etc.), and may be presented on a client system 114 (e.g., via interface module 122, etc.).

When the signed meta transaction is valid as determined at operation 515, a blockchain transaction (corresponding to the blockchain transaction indicated in the signed meta transaction) is signed by backend 160 and submitted to the blockchain, where registry smart contract 172 records the approval at operation 525. The approval allows exchange smart contract 174 to transfer the onchain asset (e.g., corresponding to an offchain asset, etc.) to the acquiring user when an offer from the acquiring user for the onchain asset is accepted or approved by the initial user.

A method 600 of authorizing a smart contract to tender payment for transfer of an onchain asset (e.g., via frontend 116, backend 160, exchange smart contract 174, payment smart contract 176, server system 110, client system 114, and/or blockchain system 140) according to an embodiment of the present invention is illustrated in FIG. 6. The acquiring user approves exchange smart contract 174 to transfer payment (e.g., USDC or other cryptocurrency, etc.) on their behalf (via payment smart contract 176) as described below.

Initially, the acquiring user interacts (e.g., via client system 114) with frontend 116 of server system 110 to initiate the approval process at operation 605. A meta transaction (including information for a blockchain transaction to initiate approval) is generated by backend 160 of server system 110 and sent (via frontend 116) to the acquiring user for signing (via client system 114) at operation 610.

Once signed, the meta transaction is sent to backend 160 (via frontend 116) for verification (e.g., the signature is verified). The signing and verification of the meta transaction may be performed in substantially the same manner described above.

When the signed meta transaction is invalid (e.g., improper signature, etc.) as determined at operation 615, backend 160 (via frontend 116) alerts or notifies the user at operation 620. The notification may indicate the reason for the invalid signature (e.g., improper signature for transaction, etc.), and may be presented on a client system 114 (e.g., via interface module 122, etc.).

When the signed meta transaction is valid as determined at operation 615, a blockchain transaction (corresponding to the blockchain transaction indicated in the signed meta transaction) is signed by backend 160 and submitted to the blockchain, where payment smart contract 176 records the approval at operation 625. The approval allows exchange smart contract 174 to transfer payment (e.g., cryptocurrency, etc.) (via payment smart contract 176) to the initial user (on behalf of the acquiring user) when an offer from the acquiring user for the onchain asset is accepted or approved by the initial user.

When an initial user or acquiring user has not previously granted permissions for exchange smart contract 174 to transfer an asset or tender payment (e.g., via registry smart contract 172 and payment smart contract 176), a one-time permission flow may be initiated. This ensures that the approvals are established prior to attempting to execute any blockchain transactions.

The one-time permission granting is handled via a meta transaction which is signed (e.g., via client system 114) in substantially the same manner described above. This signed meta transaction is verified and relayed onchain by backend 160 in substantially the same manner described above. The respective smart contract (e.g., registry smart contract 172 for the initial user and payment smart contract 176 for the acquiring user) records the approval in substantially the same manner described above.

This one-time process is designed to be seamless and only occurs when backend 160 detects that no prior approvals exist (e.g., determined from approvals recorded or stored by registry smart contract 172 and payment smart contract 176). In other words, this one-time process is obviated when the permissions have already been granted, thereby streamlining the transaction process.

These permissions may be respectively revoked by the initial user and acquiring user. For example, when an initial user decides not to proceed with listing their onchain asset as available for transfer on the frontend platform, or an acquiring user changes their mind about acquiring the onchain asset, they can interact with the corresponding smart contract (e.g., via client system 114, frontend 116, and backend 160) to revoke the approval in substantially the same manner described above for granting the approval. In this case, a meta transaction (including information for a blockchain transaction to revoke approval) may be generated by backend 160 in response to a revocation request, and signed by the initial user or acquiring user (via client system 114) in substantially the same manner described above. Backend 160 signs a blockchain transaction (corresponding to the blockchain transaction indicated in the signed meta transaction) to revoke a corresponding permission, and submits the blockchain transaction to the blockchain for the corresponding smart contract to revoke the approval.

Further, permissions can be granted for specific assets (e.g., a particular domain, a set amount of cryptocurrency, etc.), or the permissions can be generalized. The smart contracts may be configured to provide varied levels of granularity and flexibility.

In addition, an onchain and/or offchain asset may be listed on a computerized platform (or marketplace) as available for transfer prior or subsequent to the meta transactions for the permissions and/or offer generation.

An acquiring user may create a new offer for an onchain asset listed on the frontend platform. The acquiring user initially approves spending of USDC or other cryptocurrency by exchange smart contract 174 (via payment smart contract 176) as described below.

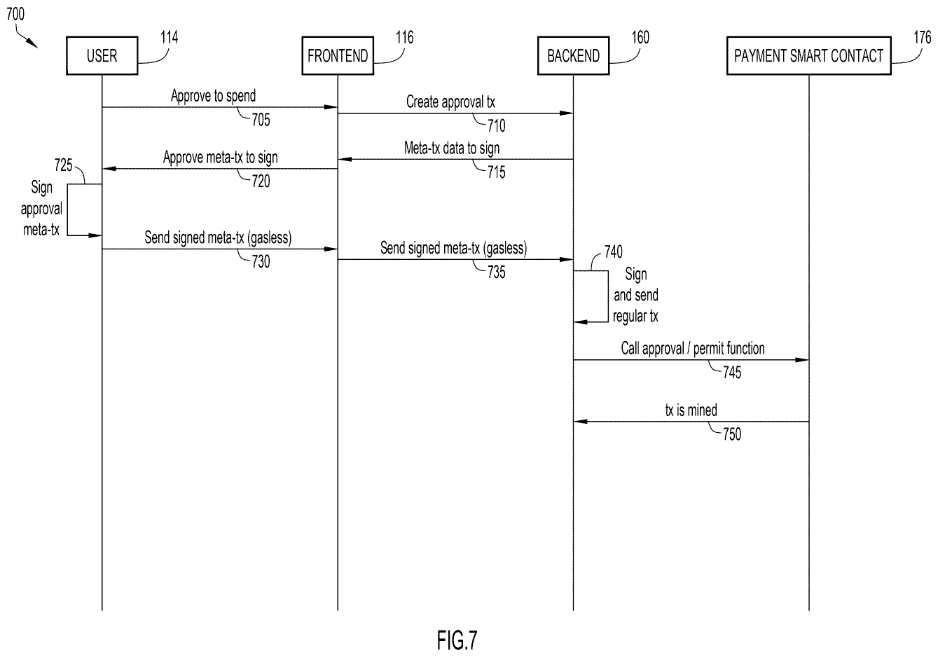

A method 700 of authorizing a smart contract to tender payment for transfer of an onchain asset (e.g., via frontend 116, backend 160, exchange smart contract 174, payment smart contract 176, server system 110, client system 114, and/or blockchain system 140) according to an embodiment of the present invention is illustrated in FIG. 7. Initially, the acquiring user interacts (e.g., via client system 114) with frontend 116 of server system 110 to initiate the approval process at flow 705. Frontend 116 sends a request to backend 160 to create a meta transaction for the approval (including information for a blockchain transaction to provide the approval) at flow 710. The meta transaction is generated by backend 160 of server system 110 and sent to frontend 116 at flow 715. The frontend sends the meta transaction to the acquiring user for signing (e.g., via client system 114) at flow 720.

The acquiring user signs the meta transaction (e.g., via client system 114) at flow 725 in substantially the same manner described above, and the signed meta transaction is sent to frontend 116 at flow 730. The frontend forwards the signed meta transaction to backend 160 at flow 735. Once the meta transaction is signed, backend 160 verifies the signed meta transaction in substantially the same manner described above, and generates a signed blockchain transaction for the approval (corresponding to the blockchain transaction indicated in the signed meta transaction) at flow 740. Since backend 160 signs the blockchain transaction, the backend is responsible for the gas (or blockchain processing) fees (as opposed to the acquiring user).

Backend 160 further calls an approval or permit function of payment smart contract 176 to record and track the approval at flow 745. The payment smart contract executes the blockchain transaction (e.g., mines the blockchain transaction) and provides notification to backend 160 at operation 750. The approval allows exchange smart contract 174 to direct payment smart contract 176 to transfer payment (e.g., cryptocurrency, etc.) to the initial user (on behalf of the acquiring user) when an offer from the acquiring user for the onchain asset is accepted or approved by the initial user.

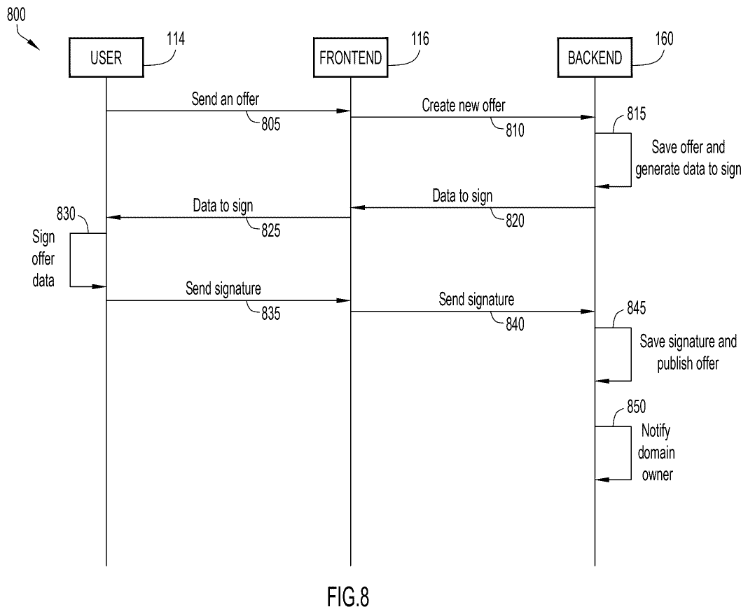

A method 800 of generating an offer to acquire an onchain asset (e.g., via frontend 116, backend 160, server system 110, and/or client system 114) according to an embodiment of the present invention is illustrated in FIG. 8. Initially, the acquiring user interacts (e.g., via client system 114) with frontend 116 of server system 110 to send an offer for an onchain asset listed by an initial user on the frontend platform at flow 805. Frontend 116 creates and sends the offer to backend 160 at flow 810. Backend 160 saves the offer and generates a meta transaction (including information for a blockchain transaction to provide the offer) for signing by the acquiring user to approve the offer at flow 815. The meta transaction is sent to frontend 116 at flow 820. The frontend sends the meta transaction to the acquiring user for signing (e.g., via client system 114) at flow 825.

The acquiring user signs the meta transaction (e.g., via client system 114) at flow 830 in substantially the same manner described above, and the signed meta transaction is sent to frontend 116 at flow 835. The frontend forwards the signed meta transaction to backend 160 at flow 840. Backend 160 saves the signature from the signed meta transaction and publishes the offer on the frontend platform (via exchange smart contract 174 executing the blockchain transaction of the signed meta transaction) at flow 845. The backend further notifies the initial user that an offer has been received for the onchain asset at flow 850. This may be accomplished by backend 160 sending a notification (via frontend 116) to client system 114 of the initial user.

An initial user may accept an offer from an acquiring user by interacting with frontend 116 to accept the offer on an onchain asset (e.g., a domain) listed on the frontend platform via a meta transaction. This leverages signatures to enable gasless transactions (e.g., the gas (or blockchain processing) fee is paid by backend 160 (as opposed to the initial or acquiring user)). Further, the initial user approves the transfer by exchange smart contract 174 by signing a meta transaction. The signed meta transaction is relayed by frontend 116 to backend 160 to facilitate the approval as described below.

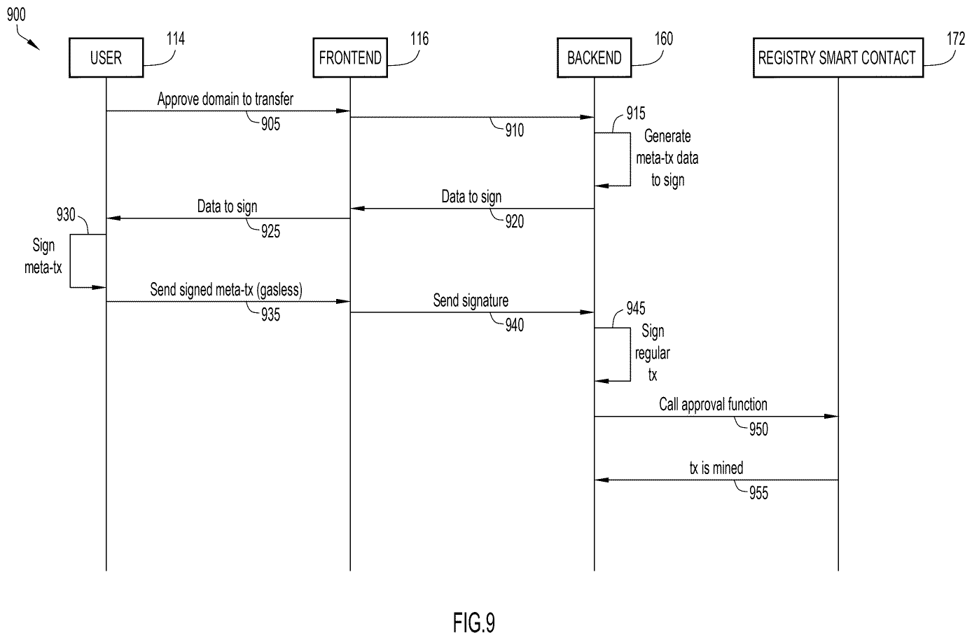

A method 900 of authorizing a smart contract to transfer an onchain asset (e.g., via frontend 116, backend 160, registry smart contract 172, exchange smart contract 174, server system 110, client system 114, and/or blockchain system 140) according to an embodiment of the present invention is illustrated in FIG. 9. Initially, the initial user interacts (e.g., via client system 114) with frontend 116 of server system 110 to initiate the approval of exchange smart contract 174 to transfer an onchain asset (on behalf of the initial user) at flow 905. Frontend 116 sends a request to backend 160 to create a meta transaction for the approval at flow 910. The meta transaction (including information for a blockchain transaction to provide the approval) is generated by backend 160 of server system 110 at flow 915 and sent to frontend 116 at flow 920. The frontend sends the meta transaction to the initial user for signing (e.g., via client system 114) at flow 925.

The initial user signs the meta transaction (e.g., via client system 114) at flow 930 in substantially the same manner described above, and the signed meta transaction is sent to frontend 116 at flow 935. The frontend forwards the signed meta transaction to backend 160 at flow 940. Once the meta transaction is signed, backend 160 verifies the signature of the meta transaction, and generates a signed blockchain transaction for the approval (corresponding to the blockchain transaction indicated in the signed meta transaction) at flow 945. Since backend 160 signs the blockchain transaction, the backend is responsible for the gas (or blockchain processing) fees (as opposed to the initial user).

Backend 160 further calls an approval or permit function of registry smart contract 172 to record and track the approval at flow 950. The registry smart contract executes the blockchain transaction (e.g., mines the blockchain transaction) and provides notification to backend 160 at operation 955. The approval allows exchange smart contract 174 to transfer the onchain asset to the acquiring user (on behalf of the initial user) when an offer from the acquiring user for the onchain asset is accepted or approved by the initial user.

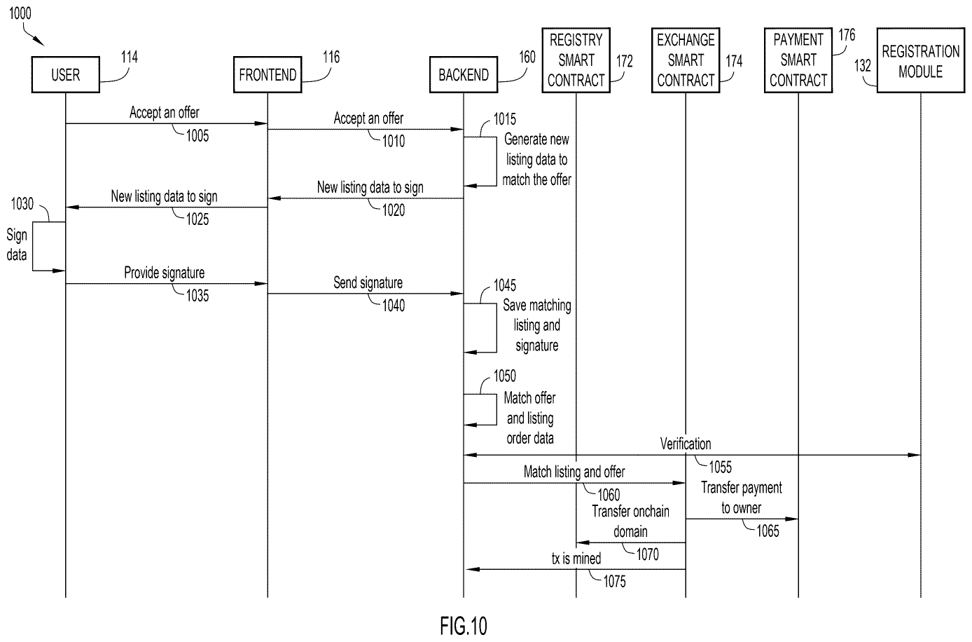

A method 1000 of accepting an offer for an onchain asset and transferring the onchain asset (e.g., via frontend 116, backend 160, registry smart contract 172, exchange smart contract 174, payment smart contract 176, server system 110, client system 114, registration system 130, and/or blockchain system 140) according to an embodiment of the present invention is illustrated in FIG. 10. Initially, the initial user interacts (e.g., via client system 114) with frontend 116 of server system 110 to approve or accept an offer received for an onchain asset (e.g., listed on the frontend platform) at flow 1005. Frontend 116 sends the acceptance to backend 160 to create a meta transaction with new listing data indicating acceptance of the offer (and information for a blockchain transaction to provide the acceptance) at flow 1010. The meta transaction (with new listing data indicating acceptance of the offer) is generated by backend 160 of server system 110 at flow 1015 and sent to frontend 116 at flow 1020. The frontend sends the meta transaction to the initial user for signing (e.g., via client system 114) at flow 1025.

The initial user signs the meta transaction (e.g., via client system 114) at flow 1030 in substantially the same manner described above, and the signed meta transaction is sent to frontend 116 at flow 1035. The frontend forwards the signed meta transaction to backend 160 at flow 1040.

Backend 160 verifies the signature of the meta transaction in substantially the same manner described above, and saves the new listing and signature at flow 1045. Backend 160 matches or associates the new listing data (or the acceptance by the initial user) with the offer from the acquiring user at flow 1050. The backend further verifies data associated with transfer of the onchain asset at flow 1055. The verification may include verifying any quantity of aspects of the onchain and/or offchain asset. For example, when an offchain domain corresponds to the onchain asset (e.g., and may be in escrow), the offchain domain can be confirmed as being properly owned and transferred before initiating transfer of the onchain asset. This may be accomplished by backend 160 verifying information retrieved from registration system 130 (e.g., via registration module 132) for the offchain domain. Further, the verification may be delayed for a time period (e.g., one day to four weeks for the offchain asset to be unlocked for proper transference). Further, gas (or blockchain processing) fees may be checked to ensure sufficient funds are available for conducting the transaction.

In addition, transfer of the onchain asset may be associated with various conditions (e.g., the initial and/or acquiring user owning a quantity of non-fungible tokens (NFTs) of a certain community, the initial and/or acquiring user owning specific NFTs, the initial and/or acquiring user owning related NFTs of a group, etc.). For example, the transfer of the onchain asset may be performed based on the initial and/or acquiring user having a specific type of non-fungible token (NFT) (e.g., digital art, etc.), and/or having a crypto account with a certain balance or value (e.g., above, at, or below a threshold value, such as a balance or value greater than $1000, etc.). The transfer of the onchain asset may be performed based on the initial and/or acquiring user having a quantity and type of non-fungible tokens (NFTs) (e.g., above, at, or below a threshold quantity, such as greater than 100 total domains, etc.). These conditions may be verified based on accessing and evaluating contents of the wallet account of the acquiring user before initiating transfer of the onchain asset.

Once the data is verified, backend 160 sends a blockchain transaction including the matching offer and listing to exchange smart contract 174 (corresponding to the blockchain transaction indicated in the signed meta transaction) at flow 1060. The blockchain transaction tenders payment and transfers the onchain asset. By way of example, exchange smart contract 174 executes the blockchain transaction to tender payment on behalf of the acquiring user to the initial user at flow 1065. The payment may include USDC or other cryptocurrency. The payment may be accomplished by exchange smart contract 174 (on behalf of the acquiring user) interacting with or directing payment smart contract 176 to provide a transaction to the blockchain indicating transference of the payment (or cryptocurrency) from the acquiring user to the initial user in accordance with the granted permission (e.g., the transaction places cryptocurrency from a wallet account of the acquiring user in a wallet account of the initial user).

Exchange smart contract 174 further executes the blockchain transaction to transfer the onchain asset to the acquiring user at flow 1070. The transfer may be accomplished by exchange smart contract 174 (on behalf of the initial user) providing a transaction to the blockchain indicating transference of the onchain asset from the initial user to the acquiring user in accordance with the granted permission (e.g., the transaction places the onchain asset from a wallet account of the initial user in a wallet account of the acquiring user). The acquisition of the onchain asset may be performed based on any required preferences. In addition, various information for the onchain asset (e.g., user information, asset information, wallet information, etc.) may be stored onchain and/or in offchain storage (e.g., database system 118, etc.)

Exchange smart contract 174 executes the blockchain transaction (e.g., mines the blockchain transaction) and provides notification to backend 160 at operation 1075. When the onchain asset corresponds to an offchain asset (e.g., Web2 or DNS domain, etc.), the backend directs registration module 132 of registration system 130 to transfer the offchain asset to the acquiring user at flow 1080. For example, DNS or other records may be edited at the current registrar to transfer the offchain asset to the acquiring user (using the same registrar). Alternatively, a request for the offchain asset to be transferred (to a new registrar) may be sent from registration system 130 to client system 114 of the initial user. The initial user performs the transfer process (e.g., with respect to unlocking and authorization codes) for management of the offchain asset in a new registrar. The offchain asset may be transferred to a registrar of choice of the acquiring user.

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). Present invention embodiments enable transactions using any of the corresponding offchain and onchain identifiers or domain names, thereby providing new functionality to an identifier of a network that is absent on that network (e.g., send cryptocurrency to a centralized or Web2 domain name, etc.).

Further, present invention embodiments provide enhanced security and control of blockchain transactions. The embodiments perform offchain verification of data for a blockchain transaction prior to commencement or performance of the blockchain transaction, thereby preventing execution of wrongful transactions and placement of erroneous data on a blockchain. Moreover, present invention embodiments enable gasless transactions for users to provide streamlined transfer of assets on blockchains.

It will be appreciated that the embodiments described above and illustrated in the drawings represent only a few of the many ways of implementing embodiments for controlling blockchain transactions based on verification performed offchain. In addition, characteristics or features of embodiments of the present invention may be combined in any fashion to provide additional embodiments of the present invention.

The environment of the present invention embodiments may include any number of computer or other processing systems (e.g., client or end-user systems, server systems, registration systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including frontend 116, interface module 122, registration module 132, smart contracts 170, registry smart contract 172, exchange smart contract 174, payment smart contract 176, decentralized applications (dApps) 148, backend 160, etc.); etc.). These systems may include any types of monitors and input devices (e.g., keyboard, mouse, voice recognition, etc.) to enter and/or view information.

It is to be understood that the software of the present invention embodiments (e.g., frontend 116, interface module 122, registration module 132, smart contracts 170, registry smart contract 172, exchange smart contract 174, payment smart contract 176, decentralized applications (dApps) 148, backend 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, registration, blockchain, and asset exchange systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., frontend 116, interface module 122, registration module 132, smart contracts 170, registry smart contract 172, exchange smart contract 174, payment smart contract 176, decentralized applications (dApps) 148, backend 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer usable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., blockchain asset information, metadata, mappings of blockchain assets to blockchains, preferences, etc.). The database system may be implemented by any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., preferences, results of transactions, notifications, domain or web site content, blockchain asset information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., blockchain assets, status and/or information of onchain and/or offchain assets, transactions, preferences, etc.).

The present invention embodiments are not limited to the specific tasks or algorithms described above, but may be utilized for controlling blockchain transactions based on verification of any aspects of corresponding onchain and/or offchain assets.

An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An onchain asset may include any asset residing on, or supported by, a blockchain or other decentralized system (e.g., Web3 asset, asset of a decentralized system, asset of a partial or hybrid decentralized system, etc.). An offchain asset may include any asset residing on, or supported by, a centralized system or a system with centralized control (e.g., Web2, Domain Name System (DNS), ICANN accredited domain names, system other than a decentralized system described above, etc.). An onchain system may include any blockchain or other decentralized system (e.g., Web3, decentralized system, partial or hybrid decentralized system, etc.), while an offchain system may include any centralized system or system with centralized control (e.g., Web2, Domain Name System (DNS), system other than a decentralized system described above, etc.).

The name or other identifier for the offchain and onchain assets may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Any quantity of any parameters, values, or other information may be associated with an asset. The information for an offchain asset may include any information arranged in any fashion (e.g., values for domain records, domain parameters, server names or addresses, etc.). Any information of an offchain asset may be stored for an onchain asset to link the assets. This information may be stored on a blockchain and/or on an offchain data source in any storage item (e.g., record, data object, etc.). The information for an onchain asset may include any information arranged in any fashion (e.g., values for asset attributes, blockchain, wallet address, user/owner information etc.). Any information of an onchain asset may be stored for an offchain asset to link the assets. This information may be stored on a blockchain and/or on an offchain data source in any storage item (e.g., record, data object, etc.). The offchain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.)).

The onchain assets may be from any desired blockchains. Availability for an onchain asset may be determined by searching any onchain and/or offchain storage for any corresponding records or information indicating existence of the onchain asset on a system. Further, availability for an offchain asset may be determined by searching any onchain and/or offchain storage for any corresponding records or information indicating existence of the offchain asset on a system.

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency (e.g., a loan or other payment) to a Web2 domain name.

A user may include, or be associated with, any type of entity (e.g., individual, company, organization, decentralized autonomous organization (DAO), etc.). Transfer of an onchain or offchain asset may include any action or transaction that provides ownership, rights, registration, custody, possession, control, and/or any other interest in the onchain or offchain asset. Further, an interest may include ownership, rights, registration, custody, possession, control, and/or any other stake or share in the onchain or offchain asset. Moreover, acquiring or obtaining an onchain or offchain asset may include obtaining ownership, rights, registration, custody, possession, control, and/or any other interest in the onchain or offchain asset.

The onchain asset (and offchain asset) may be obtained via any type of transaction. Any suitable proof of acquisition or ownership may be used to prove acquisition or ownership of an asset in order to transfer a corresponding asset (e.g., examine user wallet, examine Domain Name System (DNS) or other records for offchain assets, wallet or other signatures or authorizations, etc.).

The transfer of the onchain asset may be accomplished via any blockchain or other transaction. For example, a transfer may be accomplished by conducting a transaction on the blockchain to indicate transfer of the onchain asset to a new owner. Further, transfer of the offchain asset may be accomplished by modifying any corresponding records of the offchain asset (e.g., Domain Name System (DNS) records, etc.). Moreover, access to the records of the offchain asset may be accomplished by modifying any corresponding records of the offchain asset (e.g., Domain Name System (DNS) records, etc.), and may be performed in response to transfer of the offchain asset.

The assets and corresponding assets may be the same or different types of assets, and may be on the same or different types of systems (e.g., centralized, decentralized, etc.).

The verification may be based on any quantity of aspects of the onchain and/or offchain asset. The aspects may include any desired attributes, conditions, or events associated with an onchain and/or offchain asset (e.g., blockchain activity, user attributes, ownership of other onchain and/or offchain assets, unlocking, etc.). The verification may be performed offchain, onchain, or partly offchain and onchain. The performance of the verification may be deferred by any time period or time interval (e.g., hours, days, weeks, months, etc.) to enable occurrence of any condition or event (e.g., unlocking or transfer of an offchain domain, etc.).

Present invention embodiments may handle the entirety or any portion of gas (or blockchain processing) fees for the transfer of the onchain asset. This may be accomplished by using or conducting any quantity of meta transactions. The meta transactions may include any onchain or offchain transactions, be of any format, and include any information indicating or describing a blockchain transaction (e.g., participant information, amounts/assets to transfer, an indication of the blockchain for the transaction, one or more actions to perform, an actual blockchain transaction, etc.). Further, approval may be provided for any types of smart contracts to perform various actions on behalf of a user (e.g., transfer assets, tender payment, list assets, list offers, accept offers, etc.). Present invention embodiments may transfer onchain assets alone, or in combination with corresponding offchain assets in substantially the same manner described above.

Having described preferred embodiments of a new and improved system, method, and computer program product for controlling blockchain transactions based on verification performed offchain, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

1. A method of registering domains of a computer environment comprising:
receiving, via at least one processor, a request to register an onchain asset of a user to a recipient on a blockchain system, wherein the onchain asset resides on the blockchain system and corresponds to an offchain asset of the user, and wherein the offchain asset includes a domain name of an offchain system and the onchain asset includes a non-fungible token domain name corresponding to the domain name of the offchain system;
performing, via the at least one processor, a verification of one or more aspects of the offchain asset including ownership of the offchain asset by the user by accessing records on the offchain system from registration of the offchain asset and verifying the user as an owner of the offchain asset indicated in the records;
registering, via the at least one processor, the onchain asset to the recipient on the blockchain system in response to verification of the one or more aspects of the offchain asset on the offchain system;
registering, via the at least one processor, the offchain asset to the recipient on the offchain system in response to registration of the onchain asset to the recipient on the blockchain system; and
linking, via the at least one processor, the domain name of the offchain system to the non-fungible token domain name to conduct transactions on the blockchain system using the domain name of the offchain system.

2. The method of claim 1, wherein the offchain asset includes a centralized domain name.

3. (canceled)

4. The method of claim 1, further comprising:
deferring, via the at least one processor, performance of the verification of the one or more aspects for a period of time to enable unlocking of the offchain asset at a registrar.

5. The method of claim 1, further comprising:
conducting, via the at least one processor, meta transactions that authorize a smart contract to transfer the onchain asset on behalf of the user and to tender payment for the onchain asset on behalf of the recipient.

6. The method of claim 5, wherein the meta transactions enable performance of blockchain transactions without incurring gas fees for the user and the recipient.

7. The method of claim 5, wherein transferring the onchain asset comprises:
directing the smart contract to transfer payment for the onchain asset from a wallet account of the recipient to a wallet account of the user; and
directing the smart contract to transfer the onchain asset from the wallet account of the user to the wallet account of the recipient.

8. A system for registering domains of a computer environment comprising:
one or more memories; and
at least one processor coupled to the one or more memories, the at least one processor configured to:
receive a request to register an onchain asset of a user to a recipient on a blockchain system, wherein the onchain asset resides on the blockchain system and corresponds to an offchain asset of the user, and wherein the offchain asset includes a domain name of an offchain system and the onchain asset includes a non-fungible token domain name corresponding to the domain name of the offchain system;
perform a verification of one or more aspects of the offchain asset including ownership of the offchain asset by the user by accessing records on the offchain system from registration of the offchain asset and verifying the user as an owner of the offchain asset indicated in the records;
register the onchain asset to the recipient on the blockchain system in response to verification of the one or more aspects of the offchain asset on the offchain system;
register the offchain asset to the recipient on the offchain system in response to registration of the onchain asset to the recipient on the blockchain system; and
link the domain name of the offchain system to the non-fungible token domain name to conduct transactions on the blockchain system using the domain name of the offchain system.

9. The system of claim 8, wherein the offchain asset includes a centralized domain name.

10. (canceled)

11. The system of claim 8, wherein the at least one processor is further configured to:
defer performance of the verification of the one or more aspects for a period of time to enable unlocking of the offchain asset at a registrar.

12. The system of claim 8, wherein the at least one processor is further configured to:
conduct meta transactions that authorize a smart contract to transfer the onchain asset on behalf of the user and to tender payment for the onchain asset on behalf of the recipient.

13. The system of claim 12, wherein the meta transactions enable performance of blockchain transactions without incurring gas fees for the user and the recipient.

14. The system of claim 12, wherein transferring the onchain asset comprises:
directing the smart contract to transfer payment for the onchain asset from a wallet account of the recipient to a wallet account of the user; and
directing the smart contract to transfer the onchain asset from the wallet account of the user to the wallet account of the recipient.

15. A computer program product for registering domains of a computer environment, the computer program product comprising one or more non-transitory computer readable media having instructions stored thereon, the instructions executable by at least one processor to cause the at least one processor to:
receive a request to register an onchain asset of a user to a recipient on a blockchain system, wherein the onchain asset resides on the blockchain system and corresponds to an offchain asset of the user, and wherein the offchain asset includes a domain name of an offchain system and the onchain asset includes a non-fungible token domain name corresponding to the domain name of the offchain system;
perform a verification of one or more aspects of the offchain asset including ownership of the offchain asset by the user by accessing records on the offchain system from registration of the offchain asset and verifying the user as an owner of the offchain asset indicated in the records;
register the onchain asset to the recipient on the blockchain system in response to verification of the one or more aspects of the offchain asset on the offchain system;
register the offchain asset to the recipient on the offchain system in response to registration of the onchain asset to the recipient on the blockchain system; and
link the domain name of the offchain system to the non-fungible token domain name to conduct transactions on the blockchain system using the domain name of the offchain system.

16. The computer program product of claim 15, wherein the offchain asset includes a centralized domain name.

17. (canceled)

18. The computer program product of claim 15, wherein the instructions further cause the at least one processor to:
defer performance of the verification of the one or more aspects for a period of time to enable unlocking of the offchain asset at a registrar.

19. The computer program product of claim 15, wherein the instructions further cause the at least one processor to:
conduct meta transactions that authorize a smart contract to transfer the onchain asset on behalf of the user and to tender payment for the onchain asset on behalf of the recipient.

20. The computer program product of claim 19, wherein the meta transactions enable performance of blockchain transactions without incurring gas fees for the user and the recipient.

21. The computer program product of claim 19, wherein transferring the onchain asset comprises:
directing the smart contract to transfer payment for the onchain asset from a wallet account of the recipient to a wallet account of the user; and
directing the smart contract to transfer the onchain asset from the wallet account of the user to the wallet account of the recipient.
